(19) United States
(12) Patent Application Publication
(10) Pub. No.: US 2008/0201378 A1
(43) Pub. Date: Aug. 21, 2008

(54) Image processor, preview image display method, and computer program product

(76) Inventors: Takanori Nagahara, Kanagawa (JP); Tetsuya Sakayori, Tokyo (JP); Junichi Takami, Kanagawa (JP); Iwao Saeki, Kanagawa (JP); Takashi Yano, Tokyo (JP); Hiroko Mano, Tokyo (JP); Yoshifumi Sakuramata, Tokyo (JP)

Correspondence Address: DICKSTEIN SHAPIRO LLP, 1825 EYE STREET NW, Washington, DC, 20006-5403, US

(21) Appl. No.: 12/068,198

(22) Filed: Feb. 4, 2008

(30) Foreign Application Priority Data
Feb. 21, 2007 (JP) 2007-040629

(51) Int. Cl. G06F 17/30

(52) U.S. Cl. 707/104.1; 707/E17.019

(57) ABSTRACT

an image-retrieving unit retrieves only the image data that is to be displayed on a display unit based on a page number associated with each image data. A preview image generator generates a preview image of the retrieved image data. An operation display controller displays the generated preview image on the display unit.

### CROSS-REFERENCE TO RELATED APPLICATIONS

The present application claims priority to and incorporates by reference the entire contents of Japanese priority document 2007-040629 filed in Japan on Feb. 21, 2007.

### BACKGROUND OF THE INVENTION

1. Field of the Invention

The present invention relates to an image processor, a preview image display method, and a preview image display program.

2. Description of the Related Art

A typical image forming apparatus executes various image processes with respect to image data according to instructions of a user, prints the processed image data on a recording material, and outputs the recording material. In some image forming apparatuses, it is possible to staple or punch the recording material on which the image data has been printed. However, in most of the image forming apparatuses, whether the processes are executed according to the desire of the user can be confirmed only by printing an image on a recording material.

Japanese Patent Application Laid-open No. 2006-3568 discloses an image forming apparatus that displays as a preview image on an operation display screen. The preview image is a resultant image obtained after performing the processes instructed by the user. The preview image is generated by using the image data and information about the processes instructed by the user. Thus, the user can confirm, on the operation display screen, before the image data is actually printed, finishing of the image that is going to be printed, and can choose to stop the image data from being printed if the preview image is not as desired by the user thereby avoiding unnecessary printing.

If the original document contains multiple pages, the preview images of all the pages are first generated and only then the preview images are displayed. However, considerably longer waiting time is required until the image forming apparatus returns to an operable state if the number of the preview images is large.

### SUMMARY OF THE INVENTION

It is an object of the present invention to at least partially solve the problems in the conventional technology.

According to an aspect of the present invention, there is provided an image processor including an image-retrieving unit that retrieves, based on a page number associated with each image data, only image data that is to be displayed on a display unit; a preview image generating unit that generates a preview image indicating a process result based on various settings with respect to the image data retrieved by the image-retrieving unit; and a preview image display unit that displays the preview image generated by the preview image generating unit on the display unit.

According to another aspect of the present invention, there is provided a method of displaying preview image implemented on an image processor. The method including retrieving, based on a page number associated with each image data, from an image storage unit, only image data that is to be displayed on a display unit; generating a preview image indicating a process result based on various settings with respect to the image data retrieved at retrieving; and display the preview image generated at the generating unit on the display unit.

According to another aspect of the present invention, there is provided a computer program product that realizes the above method on a computer.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of a multifunctional peripheral according to a first embodiment of the present invention;

FIG. 2 is a schematic for explaining an example of a screen displayed on an operation display unit shown in FIG. 1;

FIG. 3 is a flowchart of preview image display processes performed by the multifunctional peripheral shown in FIG. 1;

FIG. 4 is a schematic for explaining another example of a screen displayed on the operation display unit shown in FIG. 1;

FIG. 5 is a flowchart of preview image display processes performed by a multifunctional peripheral according to a second embodiment of the present invention;

FIG. 6 is a schematic for explaining an example of a display-page specifying screen displayed on an operation display unit of the multifunctional peripheral according to the second embodiment;

FIG. 7 is a flowchart of preview image display processes performed by a multifunctional peripheral according to a third embodiment of the present invention;

FIG. 8 is a block diagram of a printing system according to a fourth embodiment of the present invention;

FIG. 9 is a block diagram of a personal computer;

FIG. 10 is a block diagram of a printer device;

FIG. 11 is a block diagram of the personal computer; and

FIG. 12 is a schematic for explaining an example of a display screen using a printer driver.

### DETAILED DESCRIPTION OF THE PREFERRED EMBODIMENTS

Exemplary embodiments of the present invention are explained below in detail with reference to the accompanying drawings. The present invention is not to be thus limited.

An image processor according to a first embodiment is a so called multifunction peripheral (MFP) that includes a copying function, a facsimile (FAX) function, a printing function, a scanning function, and a function distributing an input image (an original document image read by the scanning function or the image input by the printing or the FAX function).

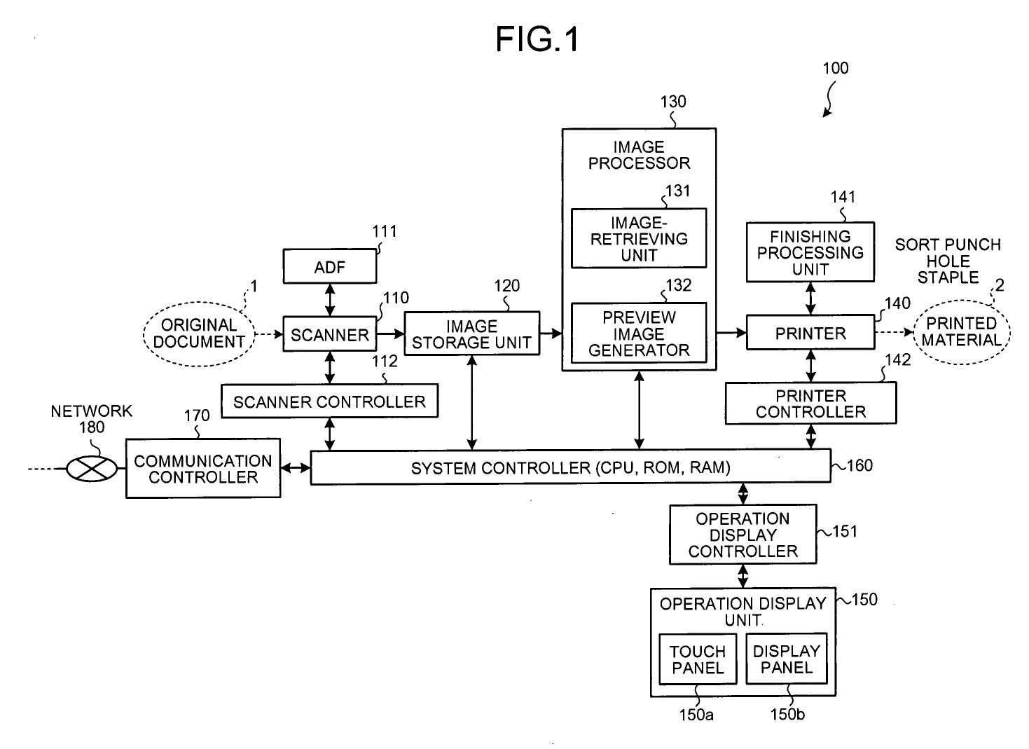

FIG. 1 is a block diagram of a MFP 100 according to the first embodiment. The MFP 100 includes a scanner 110, an auto document feeder (ADF) 111, a scanner controller 112, an image storage unit 120, an image processor 130, a printer 140, a printer controller 142, a finishing processing unit 141, an operation display unit 150, an operation display controller 151, a system controller 160, and a communication controller 170. The MFP 100 is connected to a network 180 via the communication controller 170. The MFP 100 reads the image of an original document 1, carries out an image processing, and outputs the image as a printed material 2.

The system controller 160 is connected to each component, and it controls the entire MFP 100. For example, the system controller 160 provides to the scanner 110, appropriate scanning area data with respect to a selected sheet size. The system controller 160 includes, although not shown, central processing unit (CPU), a read only memory (ROM), and a random access memory (RAM). Based on computer programs stored in the ROM, the CPU carries out operations using a work area of the RAM to execute various processes.

The computer programs executed in the MFP 100 can be provided in an installable format or an executable format file by storing in storage mediums such as a compact disk read-only memory (CD-ROM), a flexible disk (FD), a compact disk recordable (CD-R), a digital versatile disk (DVD) those can be read on a computer. The CPU of the system controller 160 reads the computer programs from the storage mediums, loads on a not shown main storage device, and causes the MFP 100 to implement various functions. Furthermore, the computer programs can be provided by storing the computer programs on the computer that is connected to the network 180 such as Internet and downloading via the network 180 or can be provided or distributed via the network 180 such as Internet.

The communication controller 170 is connected to a local area network (LAN) or the network 180 such as Internet and based on a communication protocol, exchanges image data and control data between other devices connected to the network 180.

The scanner 110, which is controlled by the scanner controller 112, converts the image of the original document 1 into digital image data. The ADF 111 can page by page provide in a sequence, a set original document of a plurality of pages to a reading position of the scanner 110. By using the ADF 111, the scanner 110 can continuously and automatically read the original document of the plurality of pages. The ADF 111 not only sends to the scanner 110, a simplex original document where printing is carried out on one side of the sheet but also sends by reversing, a duplex original document where printing is carried on both sides of the sheet. Thus, the scanner 110 can read the duplex original document. Upon receiving instructions of the system controller 160, the scanner controller 112 controls the scanner 110.

The image storage unit 120 is a buffer memory that receives the instructions of the system controller 160 and temporarily stores therein the image data read by the scanner 110 or the image data externally input via the network 180 by associating page numbers corresponding to a sequence in which the image data is read. The MFP 100 can process the image data read by the scanner 110 included therein or the image data externally input via the network 180 and can form the image.

Upon receiving the instructions of the system controller 160 and executing γ compensation and a modulation transfer function (MTF) compensation process with respect to multi-level data that is sent from the scanner 110 and that is temporarily stored in the image storage unit 120, the image processor 130 executes gray-scale processes such as a slicing process and a dithering process and binarization (or multi-valued) process. Furthermore, the image processor 130 executes various image processes (such as enlargement/reduction and adjustment of a density/color) corresponding to functions set by a user, image area editing processes (such as deletion of an area, relocation of the area, and inversion of the area) or layout processes (such as duplex printing/simplex printing, printing pages per sheet, and margin adjustment), and a generation process of a preview image indicating a finishing status.

The image processor 130 further includes an image-retrieving unit 131 and a preview image generator 132. By referring to the page numbers associated with the image data, the image-retrieving unit 131 retrieves from the image storage unit 120, the image data displayed initially while displaying the preview image on the operation display unit 150 or the image data that can be moved from the currently displayed preview image, in other words, the image data that can be displayed upon pressing page navigation buttons. The preview image generator 132 generates the preview image from the image data retrieved by the image-retrieving unit 131. The preview image generator 132 generates a main preview image and a sub preview image from one image data. The main preview image is a high-resolution preview image that is bigger than other preview images and is displayed in the central area of the normal operation display unit 150. The sub preview image is a low-resolution preview image that is smaller than the main preview image and is displayed such that a continuous relation with the main preview image can be determined. The main preview image and the sub preview image are described later.

The printer controller 142 controls the printer 140. Based on the image data processed by the image processor 130, the printer 140, which uses an electrophotographic technology executing a fixing process, carries out a deflected scanning of a light beam, develops the image by using a toner in an electrostatic latent image formed on a photosensitive member, and transfers a generated toner image onto a transfer sheet. In addition to the electrophotographic method, the printer 140 can use as printing methods, an inkjet method, a sublimation-type heat, transfer method, a silver halide photographic method, a direct thermal recording method, and a melting-type heat transfer method. Upon receiving the instructions of the system controller 160, the printer controller 142 controls the printer 140.

The finishing processing unit 141 is loaded in the printer 140. Upon receiving automatic settings or settings by the user, the finishing processing unit 141 executes finishing processes such as a sort process that sorts in a unit of copies or pages, the printed material 2 for which a printing process is carried out, a stamp process for sealing a predetermined stamp on a printing medium, a staple process for binding collected printing mediums of a plurality of sheets by a staple, or a punch process for perforating a punch hole for filing the printing mediums of the plurality of sheets in a binder or a file.

Upon receiving the instructions of the system controller 160, the operation display controller 151 controls an input and an output of the operation display unit 150. For example, the operation display controller 151 controls the output of the preview image processed by the image processor 130 to a touch panel 150a or a display panel 150b included in the operation display unit 150. To be specific, the operation display controller 151 controls display positions of the generated plurality of preview images and displays the preview images on the display panel 150b. The operation display controller 151 controls the input into the touch panel 150a. The display panel 150b and the touch panel 150a are separately shown in FIG. 1; however, the display panel 150b and the touch panel 150a can be formed as an integral unit.

The touch panel 150a detects on the touch panel 150a itself a position for electrical or magnetic touching of a pointer. As a specifying unit, which is not shown,.with respect to the touch panel 150a, a fingertip of the user, a stylus pen, another touch input tools (hereinafter, called “pointer”) can be applied. In other words, the user can touch the touch panel 150a via the pointer and can input various items including page navigation data or printing conditions.

The method of input is not limited to touch input. For example, in addition to the touch panel 150a, the operation display unit 150 can include a hard key for inputting upon the user pressing a physical key and for giving instructions such as print execution. The display panel 150b can use an exclusive display device included in the MFP 100.

The operation display unit 150, which is controlled by the operation display controller 151, receives input of the setting contents via the touch panel 150a and displays on the display panel 150b, which is a display unit, menu items for the finishing of the preview image and the image data or for setting the page navigation data.

The operation display unit 150 displays as the menu items of a setting screen, the functions to be executed in the MFP 100. The operation display unit 150 receives from the displayed menu items, the setting input by the user, and retrieves the setting contents. In other words, if the pointer touches the touch panel 150a, the operation display controller 151 detects coordinates of a pressed portion. Upon detecting that the touching is carried out in a selectable area, the operation display controller 151 receives as a selected item, a set item value.

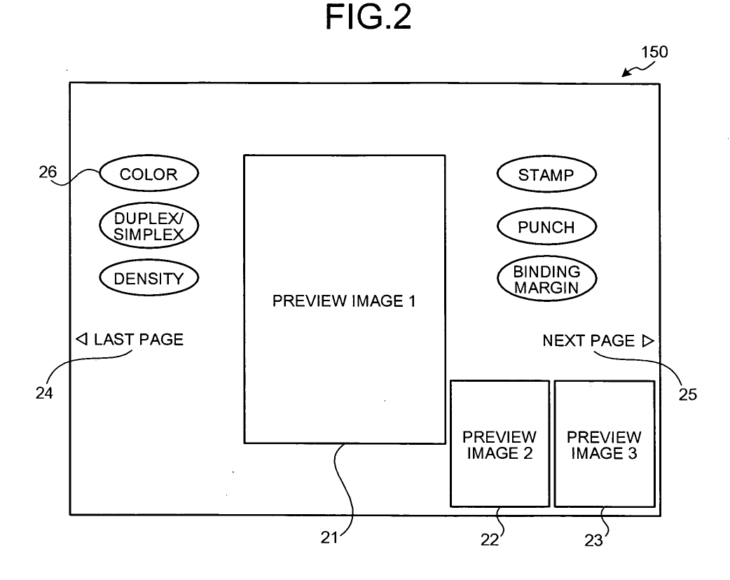

FIG. 2 is a schematic for explaining the example of a screen displayed on the operation display unit 150. A first portion of the image data, in other words, the preview images of pages 1 to 3 are displayed immediately after the image data is read by the scanner 110. As shown in FIG. 2, the image data on the page 1 is displayed as a large, main preview image 21. The image data on the pages 2 and 3 is displayed as small, sub preview images 22 and 23 on a lower right portion such that the continuous relation with the preview image on the first page can be easily determined. As the page navigation buttons, last page 24 and next page 25 are displayed on the screen. Upon pressing the button last page 24, for example, when a number of pages of the image data is 20, the preview images of pages 18 to 20 are displayed. Upon pressing the button next page 25, the page navigates and the pages 2 to 4 are displayed. The preview image on the page 2 is displayed in the center. In other words, by pressing the page navigation buttons, the image data that can be displayed on the operation display unit 150 can be moved according to the page numbers. When the preview images are displayed as shown in FIG. 2, as the movable pages, the preview images of the pages 4 and 18 to 20 are generated and based on the pressed page navigation button, the preview image of the corresponding page is displayed. As function buttons 26 indicating the image processing and finishing functions with respect to the image data, color, duplex/simplex, density, staple, punch, and binding margin are displayed.

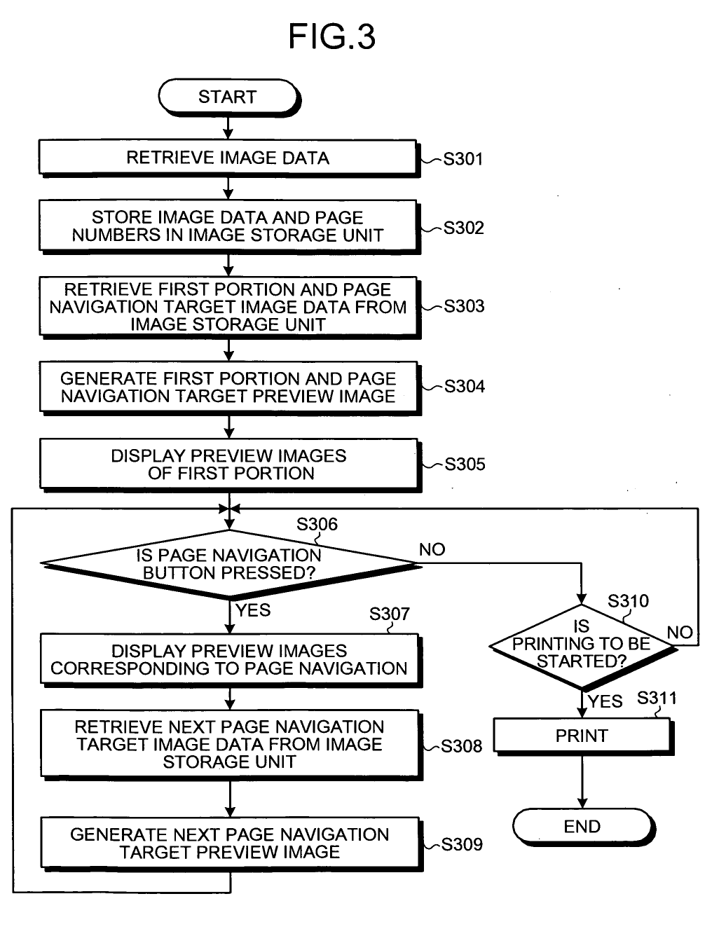

The preview image display processes performed by the MFP 100 are explained next. FIG. 3 is a flowchart of the preview image display processes performed by the scanner 110, the image-retrieving unit 131, the preview image generator 132, and the operation display controller 151.

First, the scanner 110 reads the original document 1 and retrieves the image data (step S301). The page numbers corresponding to the sequence in which the image data is retrieved are associated with the image data and retrieved. The scanner 110 associates the retrieved image data and the page numbers and stores in the image storage unit 120 (step S302). The image-retrieving unit 131 retrieves from the image storage unit 120 the first portion of the image data of the single original document and page navigation target image data (step S303). When the main preview image 21 and the subsequent two sub preview images 22 and 23 are displayed as shown in FIG. 2, the original document, for example, of 20 pages is read, and the image data of the 20 pages is stored as the single original document, the image data of the pages 1 to 3 is retrieved as the image data of the first portion and the image data of the page 4 and the pages 18 to 20 is retrieved as the page navigation target image data. It is not necessary to retrieve the image data from the image storage unit 120 after the entire image data is read as the single original document by the scanner 110. The image data can be retrieved from the image storage unit 120 before the image data is read. For example, the image data can be retrieved nearly simultaneously with the storing of the image data in the image storage unit 120.

The preview image generator 132 generates the preview image from the retrieved image data (step S304). To be specific, the main preview image and the sub preview images are generated from the image data. Among the preview images generated by the preview image generator 132, the operation display controller 151 displays on the operation display unit 150, the preview image corresponding to the first portion (step S305). For example, as shown in FIG. 2, the main preview image 21 of the page 1 and the sub preview images 22 and 23 of the pages 2 and 3 are displayed. The operation display unit 150 determines whether the page navigation button is pressed (step S306).

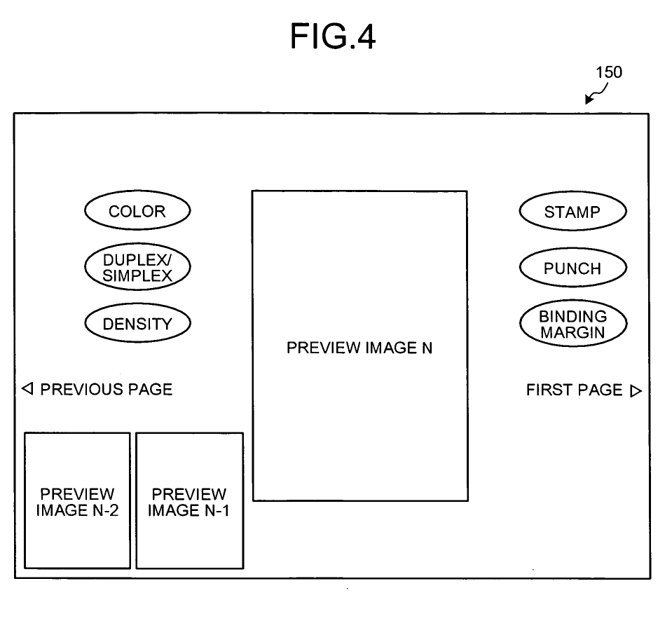

Upon determining that the page navigation button is pressed (Yes at step S306), the preview image generator 132 displays the preview images corresponding to page navigation on the operation display unit 150 (step S307). FIG. 4 is a schematic for explaining another example of a screen displayed on the operation display unit 150. For example, when Last page 24 is pressed and Next page 25 is repeatedly pressed on an initial display screen shown in FIG. 2, the preview images including last pages shown in FIG. 4 are displayed. In FIG. 4, as the page navigation buttons, First page and Previous page buttons are displayed. Upon pressing First page, the preview image corresponding to the first portion is displayed.

The image-retrieving unit 131 retrieves next page navigation target image data from the image storage unit 120 (step S308). The preview image generator 132 generates a next page navigation target preview image (step S309). Thus, because only the movable preview image is generated when the preview image is displayed, a not required waiting time is not generated at the time of an operation and an operating efficiency can be enhanced. For example, in FIG. 4, as the movable pages, the preview images of the pages 1 to 3 and the preview image of the page 17 that is a previous page are generated. The process returns to step S306. Upon determining at step S306 that the page navigation button is not pressed (No at step S306), the operation display controller 151 determines whether to start printing (step S310). To be specific, by determining whether a not shown print button is pressed, the operation display controller 151 determines whether to start printing. Upon determining not to start printing (No at step S310), the process returns to step S306.

Upon determining to start printing (Yes at step S310), the image processor 130 executes the image processes set with respect to the image data and executes the printing process through the printer 140 (step S311). Furthermore, the page navigation or the printing process can be executed by determining whether a function button is pressed, generating the main and the sub preview images of the currently displayed page corresponding to the function and page navigation target page when the function button is pressed, and displaying the preview image corresponding to the selected function.

Thus, by generating only the preview images of the pages to be displayed next and the pages likely to be displayed when the page navigation button is pressed, i.e., by not generating the preview images of all read image data at one time, a time for generating the preview image can be shortened. Due to this, the preview images can be displayed and operations can be started within a short period of time. Furthermore, only the current page or the pages likely to be displayed by page navigation can be stored in a memory for the preview images. Thus, the required memory can be reduced.

A second embodiment of the present invention is now explained below. The functions and a structure of the MFP applied in the present invention are substantially the same as the MFP 100 according to the first embodiment. Thus, only the portions that are different from the MFP 100 are explained here.

In the second embodiment, the operation display controller 151 displays a page specifying screen that specifies a range of the pages to be displayed in the preview image and receives input of a display page range. In addition to the functions and the structure mentioned earlier, the image-retrieving unit 131 retrieves from the image storage unit 120, the image data corresponding to the display page range received by the operation display controller 151.

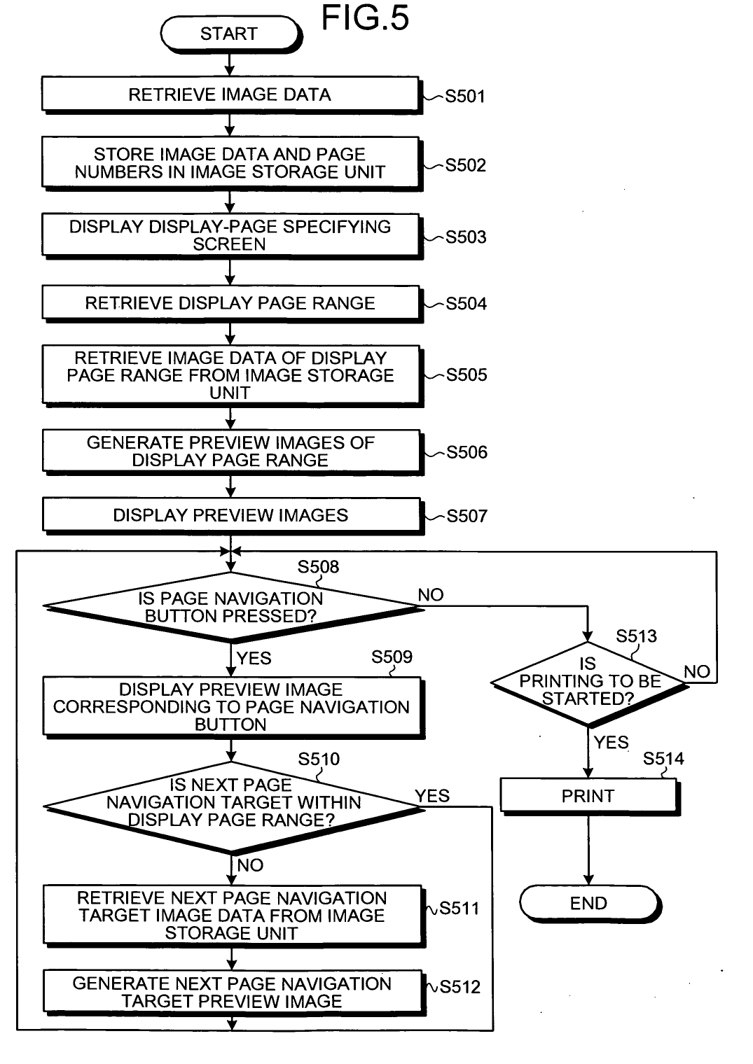

The preview image display processes performed by the MFP according to the second embodiment are explained next. FIG. 5 is a flowchart of the preview image display processes performed by the scanner, the image-retrieving unit, the preview image generator, and the operation display controller according to the second embodiment.

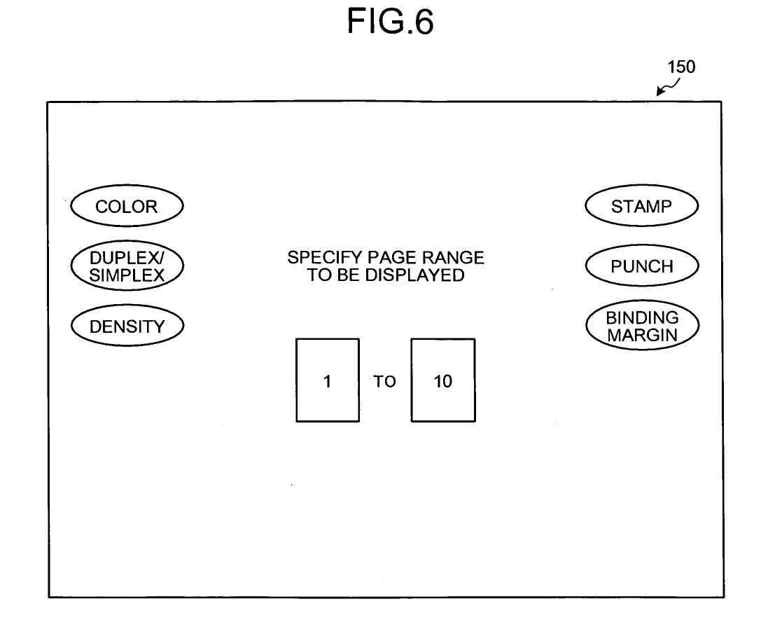

First, the scanner 110 reads the original document 1 and retrieves the image data (step S501). The page numbers corresponding to the sequence in which the image data is retrieved are associated with the image data and retrieved. The scanner 110 associates the retrieved image data and the page numbers and stores in the image storage unit 120 (step S502). The operation display controller 151 displays the display-page specifying screen on the operation display unit 150 (step S503). FIG. 6 is a schematic for explaining the example of the display-page specifying screen displayed on the operation display unit. The operation display controller 151 retrieves the display page range (step S504). As shown in FIG. 6, for example, among the original document of 20 pages, when the pages 1 to 10 are to be confirmed in the preview image, the pages 1 to 10 can be specified.

The image-retrieving unit 131 retrieves the image data of the display page range from the image storage unit 120 (step S505). The preview image generator 132 generates the preview image from the retrieved image data (step S506). Among the preview images generated by the preview image generator 132, the operation display controller 151 displays on the operation display unit 150, the preview images corresponding to the first portion (step S507). The preview images of the first portion within the display page range are displayed. The present embodiment is not limited only to display of the first portion. A prior decided page, for example, the page 3 or a page 5 that is a middle page in the display page range can also be displayed. All the preview images in the display page range can be displayed in equal size on the screen.

The operation display unit 150 determines whether the page navigation button is pressed (step S508). Upon determining that the page navigation button is pressed (Yes at step S508), the preview image generator 132 displays the preview image corresponding to page navigation on the operation display unit 150 (step S509). The image-retrieving unit 131 determines whether the next page navigation target is within the display page range (step S510).

Upon determining that the next page navigation target is not within the display page range (No at step S510), the image-retrieving unit 131 retrieves the next page navigation target image data from the image storage unit 120 (step S511). Furthermore, upon determining that the next page navigation target is not within the display page range, the display page range can be again retrieved by returning to step S503. The preview image generator 132 generates the next page navigation target preview image (step S512) and the process returns to step S508. At step S510, upon determining that the next page navigation target is within the display page range (Yes at step S510), the process returns to step S508.

Upon determining at step S508 that the page navigation button is not pressed (No at step S508), the operation display controller 151 determines whether to start printing (step S513). To be specific, by determining whether the not shown print button is pressed, the operation display controller 151 determines whether to start printing. Upon determining not to start printing (No at step S513), the process returns to step S508.

Upon determining to start printing (Yes at step S513), the image processor 130 executes the image processes set with respect to the image data and executes the printing process through the printer 140 (step S514). Furthermore, the page navigation or printing process can be executed by determining whether the function button is pressed, generating the preview image of the currently displayed page corresponding to the function and the page navigation target page when the function button is pressed, and displaying the preview image of the current page.

Thus, by generating only the preview images within the specified display page range without generating the preview images with respect to all read image data when the image data is read, only the preview images to be confirmed are generated and the time for generating the preview images can be shortened. Due to this, the preview images can be displayed and the operations can be started within the short period of time. Furthermore, the pages to be displayed can be stored in the memory for the preview images. Thus, the required memory can be reduced.

A third embodiment of the present invention is now explained below. The functions and the structure of an MFP according to the third embodiment are substantially the same as those of the MFP 100. Therefore, only the portions that different from the MFP 100 are explained here.

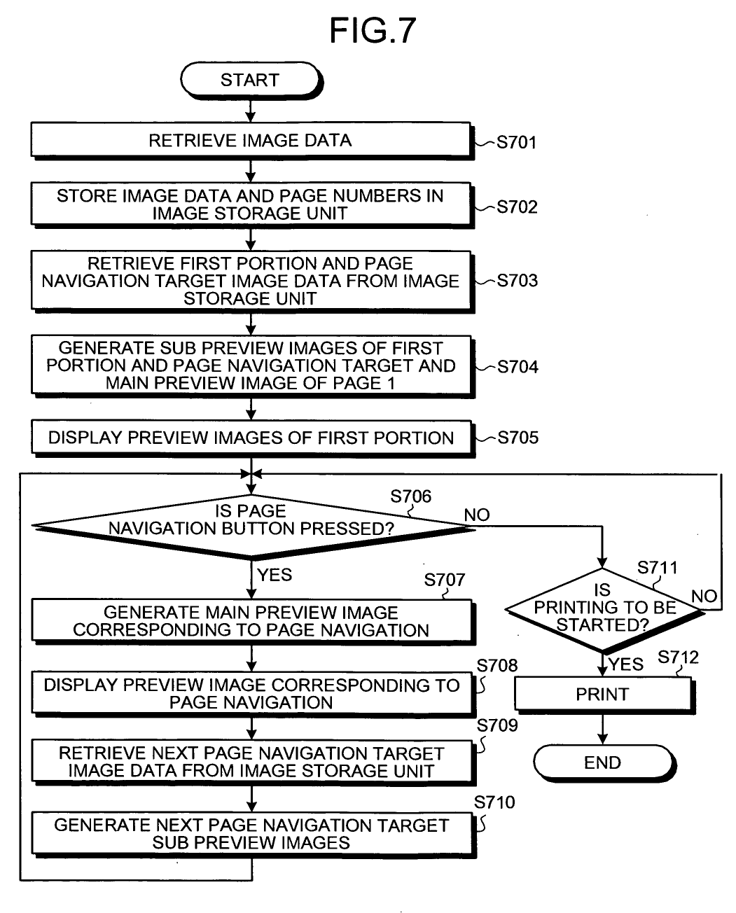

The preview image display processes performed by the MFP according to the third embodiment are explained below. FIG. 7 is a flowchart of the preview image display processes performed by the scanner, the image-retrieving unit, the preview image generator, and the operation display controller according to the third embodiment.

First, the scanner 110 reads the original document 1 and retrieves the image data (step S701). The page numbers corresponding to the sequence in which the image data is retrieved are associated with the image data and retrieved. The scanner 110 associates the retrieved image data and the page numbers and stores in the image storage unit 120 (step S702). The image-retrieving unit 131 retrieves from the image storage unit 120, the first portion of the image data of the single original document and the page navigation target image data (step S703). The preview image generator 132 generates the sub preview images of the retrieved image data and the main preview image of the page 1 (step S704).

Among the preview images generated by the preview image generator 132, the operation display controller 151 displays on the operation display unit 150, the preview images corresponding to the first portion (step S705). The operation display unit 150 determines whether the page navigation button is pressed (step S706). Upon determining that the page navigation button is pressed (Yes at step S706), the preview image generator 132 generates the main preview image corresponding to page navigation (step S707). Thus, upon pressing the page navigation button, because the main preview image is generated, only the displayed main preview image is generated and is stored in the memory. Thus, an unused memory can be removed.

The preview image generator 132 displays on the operation display unit 150, the preview images corresponding to page navigation (step S708). For example, at the time of retrieving the image data, as shown in FIG. 2, a first page is displayed as the main preview image 21. Next, the image-retrieving unit 131 retrieves the next page navigation target image data from the image storage unit 120 (step S709). The preview image generator 132 generates next page navigation target sub preview images (step S710) and the process returns to step S706.

Upon determining at step S706 that the page navigation button is not pressed (No at step S706), the operation display controller 151 determines whether to start printing (step S711). To be specific, by determining whether the not shown print button is pressed, the operation display controller 151 determines whether to start printing. Upon determining not to start printing (No at step S711), the process returns to step S706.

Upon determining to start printing (Yes at step S711), the image processor 130 executes the image processes set with respect to the image data and executes the printing process through the printer 140 (step S712). Furthermore, the page navigation or the printing process can be executed by determining whether the function button is pressed, generating the main and the sub preview images of the currently displayed page corresponding to the function and the sub preview images of the page navigation target page when the function button is pressed, and displaying the preview image of the current page.

Thus, only the sub preview images of the currently displayed page and the pages likely to be displayed upon instructing page navigation can be generated and upon instructing page navigation, the main preview image can be generated and displayed. Thus, a memory capacity for storing the main preview images can be reduced and the memory can be effectively used.

Although the first to the third embodiments are explained with the help of the MFP 100, the present invention is not limited to an MFP. For example, the image processor such as a printer device can be connected to a personal computer and predetermined computer programs can be installed in a storage device such as a hard disk drive (HDD) of the personal computer. Thus, based on the computer programs, a central processing unit (CPU) of the personal computer can be operated and effects similar to the various effects mentioned earlier can be obtained.

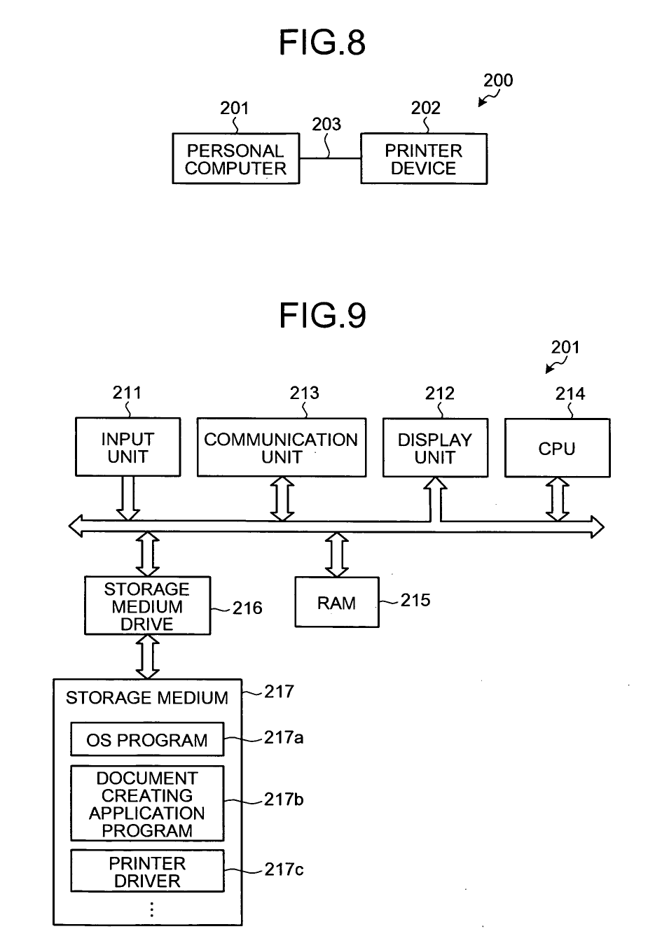

FIG. 8 is a block diagram of a printing system according to a forth embodiment of the present invention. In a printing system 200 shown in FIG. 8, a personal computer 201 that delivers the image data and a printing job including printing conditions for printing the image data and a printer device 202 for printing the image data are connected via a cable 203.

The personal computer 201 delivers as the printing job to the printer device, 202, the image data corresponding to created documents and printing condition data (such as page orientation, duplex, pages per sheet, binding, staple, punch, and enlargement/reduction) set for printing the documents.

Based on the printing job delivered from the personal computer 201, the printer device 202 prints the image data. To be specific, based on the printing condition data (such as page orientation, duplex, pages per sheet, binding, staple, punch, and enlargement/reduction) included in the printing job, the printer device 202 prints the image data included in the printing job, on a media such as a sheet.

A concrete structure of the personal computer 201 and the printer device 202 is sequentially explained below.

FIG. 9 is a block diagram of a personal computer. In FIG. 9, the personal computer 201 includes an input unit 211 for inputting data, a display unit 212, a communication unit 213 for communicating data, a CPU 214 that exercises a control of entire device, a RAM 215 that is used as a work area of the CPU 214, a storage medium drive 216 that reads/writes data on a storage medium 217, and the storage medium 217 on which the various computer programs are stored for operating the CPU 214.

The input unit 211, which is a user interface for inputting data, includes a keyboard that includes a cursor key, a numeric input key, and various functional keys, a mouse and a slice pad for selecting keys on a display screen of the display unit 212. An operator gives operation instructions to the CPU 214.

The display unit 212 is formed of a cathode ray tube (CRT) and a liquid crystal display (LCD). The display unit 212 carries out display based on display data input from the CPU 214. The communication unit 213 communicates data with external devices. For example, the communication unit communicates data with the printer device 202 via the cable 203.

The CPU 214 is a central controlling unit that controls the entire device based on the computer programs stored in the storage medium 217. The input unit 211, the display unit 212, the communication unit 213, the RAM 215, and the storage medium drive 216 are connected to the CPU 214 and the CPU 214 controls data communication, reading of application programs by accessing memory, reading/writing of various data, data/command input, and display. The CPU 214 delivers as the printing job to the printer device 202, the image data input from the input unit 211 and the printing condition data of the image data via the communication unit 213.

The RAM 215 includes a work memory that stores therein the specified computer programs, input instructions, input data, and processing results and a display memory that temporarily stores therein the display data to be displayed on the display screen of the display unit 212.

The storage medium 217 stores therein various computer programs such as operating system (OS) programs 217a executable on the CPU 214 (for example, WINDOWS (registered trademark)), document creating application programs 217b, and a printer driver 217c corresponding to the printer device 202, or data. The storage medium 217 includes optical, magnetic, or electrical storage mediums such as the flexible disk, the hard disk, the CD-ROM, a digital versatile disk read only memory (DVD-ROM), a magneto-optic (MO), and a personal computer (PC) card. The various computer programs mentioned earlier are stored in the storage medium 217 in a data format that can be read by the CPU 214. The various computer programs can be prior recorded in the storage medium 217 or stored in the storage medium 217 by downloading via a communication line. The various computer programs can be distributed via the communication line.

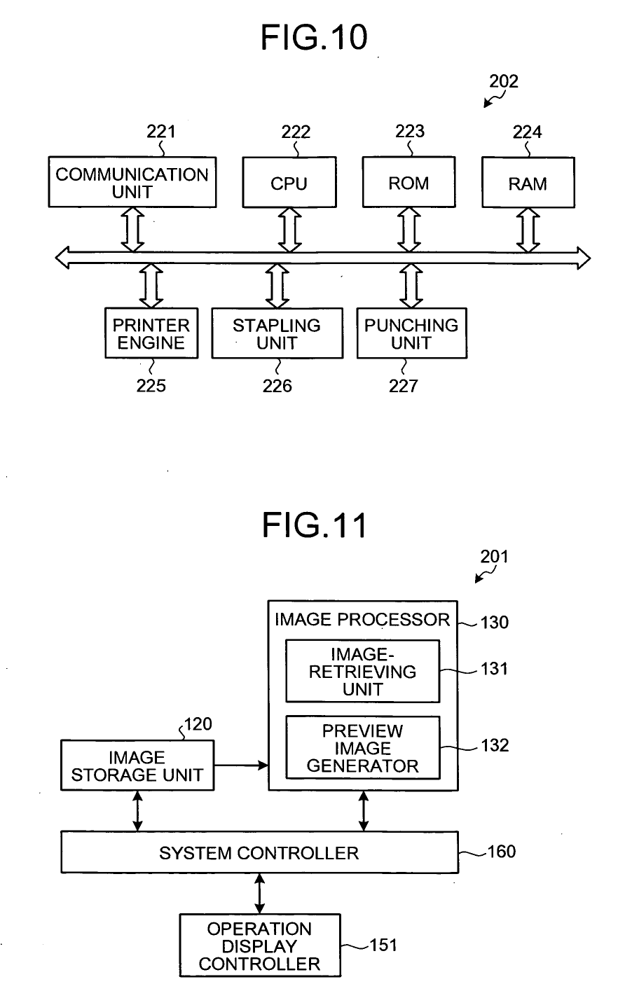

FIG. 10 is a block diagram of the printer device. As shown in FIG. 10, the printer device 202 includes a communication unit 221 that carries out data communication, a CPU 222 that exercises the control of the entire printer device 202, a ROM 223 that stores therein the various control programs that cause the CPU 222 to operate, a RAM 224 that temporarily stores therein print data of the printing job input from the work area of the various control programs and the personal computer 201, a printer engine 225 for printing the print data onto a transfer sheet, a stapling unit 226 for stapling the sheets on which the print data is printed, and a punching unit 227 for perforating punch holes onto the transfer sheet on which the print data is printed. In other words, the printer device 202 includes a duplex printing function, a punch function, and a staple function.

The communication unit 221 communicates data with the external devices. For example, the communication unit 221 communicates data with the personal computer 201.

The CPU 222 is a central controlling unit that controls the entire device based on the various control programs stored in the ROM 223. The communication unit 221, the ROM 223, the RAM 224, the printer engine 225, the stapling unit 226, and the punching unit 227 are connected to the CPU 222 and the CPU 222 controls data communication and printer operations.

The ROM 223 stores therein the various control programs that cause the CPU 222 to operate and parameters used in the processes. The RAM 224 includes the work memory that stores therein the specified control programs, the process results, and the received image data.

The printer engine 225 that is formed of a printer engine of the electrophotographic method prints the print data onto the transfer sheet. In addition to the electrophotogaphic method, the printer device 202 can use as the printing methods, the inkjet method, the sublimation-type heat transfer method, the silver halide photographic method, the direct thermal recording method, and the melting-type heat transfer method.

The printer driver 217c of the personal computer 201 is explained next. The printer driver 217c is a software program that is designed such that another computer programs can be operated with respect to specific computer programs without disturbing hardware of the printer device 202 or internal “languages”. The printer driver 217c controls the printer device 202 and processes the output data.

Based on the printer driver 217c, the CPU 214 of the personal computer 201 generates or displays a final conceptual drawing based on the image data and the print condition data of the image data input from the input unit 211 and transfers to the printer device 202, the image data created by the document creating application programs 217b.

FIG. 11 is a block diagram of the personal computer. In the personal computer 201, the CPU 214 is operated based on the printer driver 217c. As shown in FIG. 11, the personal computer 201 includes the image storage unit 120, the image processor 130, the operation display controller 151, and the system controller 160.

Thus, because the CPU 214 is operated based on the printer driver 217c and a system configuration of the personal computer 201 is similar to that of the MFP 100 shown in FIG. 1, the effects similar to the various effects explained in the first to the third embodiments can be obtained.

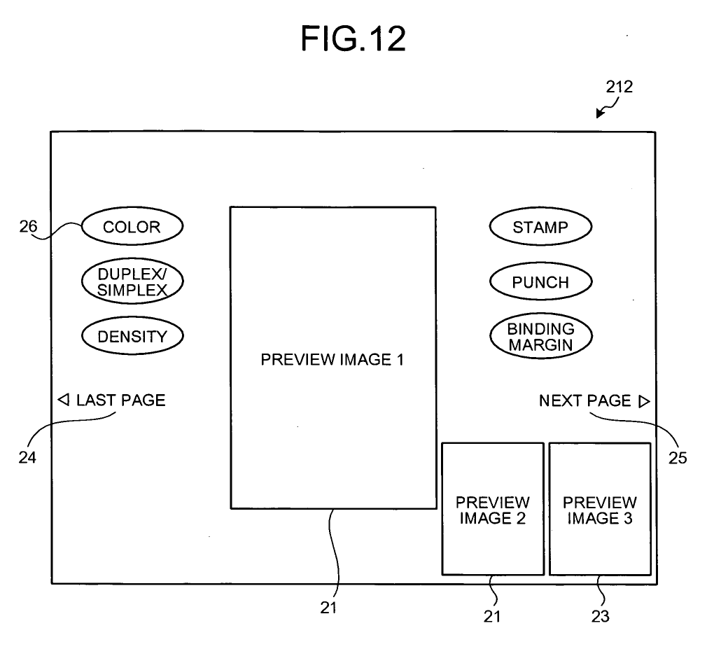

FIG. 12 is a schematic for explaining the example of the display screen using the printer driver. The screen shown in FIG. 12 is displayed when activation of the printer driver 217c is selected on the display screen of the document creating application programs 217b and an activation screen of the OS programs 217a. As shown in FIG. 12, the display unit 212 (similar to the operation display screen of the MFP 100) displays the display screen that generates or displays the preview image based on the image data and the print condition data of the image data input from the input unit 211.

In the present embodiment, the printer driver 217c causes the CPU 214 of the personal computer 201 to operate and the operation display screen that generates or displays the final conceptual drawing based on the image data and the print condition data of the image data input from the input unit 211 is displayed. The present invention is not to be thus limited. The operation display screen can be displayed by operating the CPU 214 of the personal computer 201 based on the document creating application programs 217b or the OS programs 217a.

Even if the present invention carried out by the inventor is specifically explained based on the exemplary embodiments, the present invention is not to be thus limited. Various modifications can be made without departing from the scope of the invention. Furthermore, the structure and the functions explained in the first to the fourth embodiments can be freely combined.

According to an aspect of the present invention, only a preview image of image data to be displayed is generated. In other words, preview images of all image data are not generated. Due to this, time required for generating the preview images can be shortened, an operation can be carried out in a short waiting time, and operability for a user can be enhanced.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processor comprising:
an image-retrieving unit that retrieves, based on a page number associated with each image data, only image data that is to be displayed on a display unit;
a preview image generating unit that generates a preview image indicating a process result based on various settings with respect to the image data retrieved by the image-retrieving unit; and
a preview image display unit that displays the preview image generated by the preview image generating unit on the display unit.

2. The image processor according to claim 1, further comprising an image storage unit that stores therein the image data whereto page numbers are associated.

3. The image processor according to claim 2, further comprising a page navigation unit that sequentially moves, based on the page numbers, the image data to be displayed on the display unit, wherein
the image-retrieving unit retrieves from the image storage unit, the image data of pages that can be moved by the page navigation unit.

4. The image processor according to claim 3, wherein the image-retrieving unit that retrieves by including, as the movable pages of the image data corresponding to a first portion of the page numbers, the image data corresponding to a last portion of the page numbers.

5. The image processor according to claim 2, further comprising a range retrieving unit that retrieves, based on the pages numbers of the image data stored in the image storage unit, a predetermined range, wherein
the image-retrieving unit retrieves, from the image storage unit, the image data in the range retrieved by the range retrieving unit.

6. The image processor according to claim 1, wherein
the preview image generating unit generates, from the image data, a high-resolution preview image and a low-resolution preview image, and
the preview image display unit selectively displays, for each display position of the display unit, the high-resolution preview image and the low-resolution preview image.

7. The image processor according to claim 1, wherein the preview image generating unit generates a low-resolution preview image from the image data retrieved by the image-retrieving unit, and generates, upon displaying a preview image in the predetermined display position of the display unit, a high-resolution preview image.

8. A method of displaying preview image implemented on an image processor, the method comprising:
retrieving, based on a page number associated with each image data, from an image storage unit, only image data that is to be displayed on a display unit;
generating a preview image indicating a process result based on various settings with respect to the image data retrieved at retrieving; and
display the preview image generated at the generating unit on the display unit.

9. The method according to claim 8, further comprising sequentially moving, based on the page numbers, the image data to be displayed on the display unit, wherein
the retrieving includes retrieving from the image storage unit, the image data of pages that can be moved by at the moving.

10. The method according to claim 9, wherein the retrieving includes retrieving by including, as the movable pages of the image data corresponding to a first portion of the page numbers, the image data corresponding to a last portion of the page numbers.

11. The method according to claim 8, further comprising second retrieving including retrieving, based on the pages numbers of the image data stored in the image storage unit, a predetermined range, wherein
the retrieving includes retrieving, from the image storage unit, the image data in the range retrieved at the second retrieving.

12. The method according to claim 8, wherein
the generating includes generating, from the image data, a high-resolution preview image and a low-resolution preview image, and
the displaying includes selectively displaying, for each display position of the display unit, the high-resolution preview image and the low-resolution preview image.

13. The method according to claim 8, wherein the generating includes generating a low-resolution preview image from the image data retrieved at the retrieving, and generating, upon displaying a preview image in the predetermined display position of the display unit, a high-resolution preview image.

14. A computer program product that includes a computer-readable recording medium and a computer program stored on the computer-readable recording medium, wherein when executed the computer program realizes a method of displaying preview image on a computer, the computer program causing the computer to execute:
retrieving, based on a page number associated with each image data, from an image storage unit, only image data that is to be displayed on a display unit;
generating a preview image indicating a process result based on various settings with respect to the image data retrieved at retrieving; and
display the preview image generated at the generating unit on the display unit.

15. The computer program product according to claim 14, wherein the computer program further causing the computer to execute sequentially moving, based on the page numbers, the image data to be displayed on the display unit, wherein
the retrieving includes retrieving from the image storage unit, the image data of pages that can be moved by at the moving.

16. The computer program product according to claim 15, wherein the retrieving includes retrieving by including, as the movable pages of the image data corresponding to a first portion of the page numbers, the image data corresponding to a last portion of the page numbers.

17. The computer program product according to claim 14, wherein the computer program further causing the computer to execute second retrieving including retrieving, based on the pages numbers of the image data stored in the image storage unit, a predetermined range, wherein
the retrieving includes retrieving, from the image storage unit, the image data in the range retrieved at the second retrieving.

18. The computer program product according to claim 14, wherein
the generating includes generating, from the image data, a high-resolution preview image and a low-resolution preview image, and
the displaying includes selectively displaying, for each display position of the display unit, the high-resolution preview image and the low-resolution preview image.

19. The computer program product according to claim 14, wherein the generating includes generating a low-resolution preview image from the image data retrieved at the retrieving, and generating, upon displaying a preview image in the predetermined display position of the display unit, a high-resolution preview image.
